(19) United States
(12) Patent Application Publication
(10) Pub. No.: US 2025/0116218 A1
(43) Pub. Date: Apr. 10, 2025

(54) EXHAUST SYSTEM AND STRADDLED OFF-ROAD TRAVELING VEHICLE

(71) Applicant: KAWASAKI MOTORS, LTD., Akashi-shi (JP)

(72) Inventors: Hiroaki HAYASHI, Akashi-shi (JP); Yu TSUDOME, Akashi-shi (JP); Kozo ARAI, Akashi-shi (JP); Tomokazu HIRANO, Akashi-shi (JP); Kaoru MURAKAMI, Akashi-shi (JP)

(21) Appl. No.: 18/895,294

(22) Filed: Sep. 24, 2024

(30) Foreign Application Priority Data
Oct. 6, 2023 (JP) 2023-174360

(51) Int. Cl. F01N 3/10; F01N 3/28

(52) U.S. Cl. CPC F01N 3/105; F01N 3/2803

(57) ABSTRACT

An exhaust system of a straddled off-road traveling vehicle includes: an exhaust passage extending from an exhaust port of an internal combustion engine of the straddled off-road traveling vehicle and including a lateral portion passing through a lateral space of the internal combustion engine; a silencer connected to the exhaust passage at a position downstream of the lateral portion in a flow direction of an exhaust gas; a main catalyst located inside the silencer; and a precatalyst located at the lateral portion and having a heat capacity smaller than a heat capacity of the main catalyst.

### CROSS REFERENCE TO RELATED APPLICATIONS

The present application claims priority to and the benefit of Japanese Patent Application No. 2023-174360 filed on Oct. 6, 2023, the entire disclose of which is incorporated herein by reference.

### BACKGROUND ART

### Field of the Invention

The present disclosure relates to an exhaust system and a straddled off-road traveling vehicle.

### Description of the Related Art

Japanese Laid-Open Patent Application Publication No. 2021-188606 discloses an exhaust system of a straddled vehicle. The exhaust system includes two catalysts located at an exhaust passage connected to an exhaust port of an engine. Regarding these two catalysts, an upstream catalyst is located at such a position as to first purify unpurified exhaust gas discharged from the exhaust port, and a downstream catalyst is located downstream of the upstream catalyst and is set to have a larger heat capacity than the upstream catalyst.

In Japanese Laid-Open Patent Application Publication No. 2021-188606, the upstream catalyst and the downstream catalyst are located under the engine. When the straddled vehicle is an off-road traveling vehicle, the two catalysts influence the securement of a large clearance between a lower side of a vehicle body of the straddled vehicle and a ground surface.

### SUMMARY OF THE INVENTION

An object of one aspect of the present disclosure is to provide an exhaust system suitable for a straddled off-road traveling vehicle.

An exhaust system according to one aspect of the present disclosure is an exhaust system of a straddled off-road traveling vehicle, the exhaust system including: an exhaust passage extending from an exhaust port of an internal combustion engine of the straddled off-road traveling vehicle and including a lateral portion passing through a lateral space of the internal combustion engine; a silencer connected to the exhaust passage at a position downstream of the lateral portion in a flow direction of an exhaust gas; a main catalyst located inside the silencer; and a precatalyst located at the lateral portion and having a heat capacity smaller than a heat capacity of the main catalyst.

### BRIEF DESCRIPTION OF THE DRAWINGS

FIG. 1 is a left side view showing one example of the configuration of a straddled off-road traveling vehicle according to an exemplary embodiment.

FIG. 2 is a right side view of the straddled off-road traveling vehicle of FIG. 1.

FIG. 3 is a perspective view showing the configuration of an exhaust system of the straddled off-road traveling vehicle of FIG. 1 and its vicinity.

FIG. 4 is a front view showing the configuration of the exhaust system of the straddled off-road traveling vehicle of FIG. 1 and its vicinity.

FIG. 5 is a top view showing the configuration of the exhaust system of the straddled off-road traveling vehicle of FIG. 1 and its vicinity.

FIG. 6 is a schematic diagram showing the configuration of a silencer of the straddled off-road traveling vehicle of FIG. 1.

### DETAILED DESCRIPTION

Hereinafter, an exemplary embodiment of the present disclosure will be described with reference to the drawings. The embodiment described below is a comprehensive or specific example. Among components in the following embodiment, components that are not recited in independent claims which embody the broadest concept of the present disclosure will be described as optional components. The diagrams in the attached drawings are schematic diagrams and are not necessarily strictly drawn. In the diagrams, the same reference signs are used for the substantially identical components, and the repetition of the same explanation may be avoided, or such explanation may be simplified. In the embodiment below, a straddled vehicle is described as a motorcycle but may be a motor three-wheeler or a buggy car.

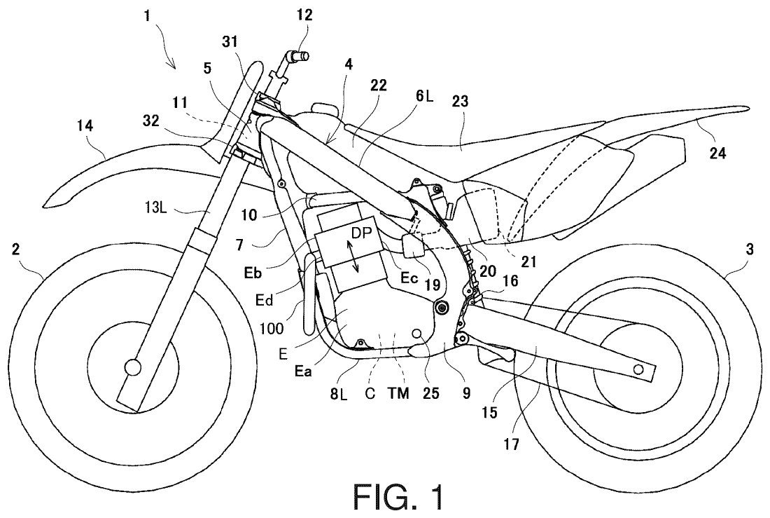

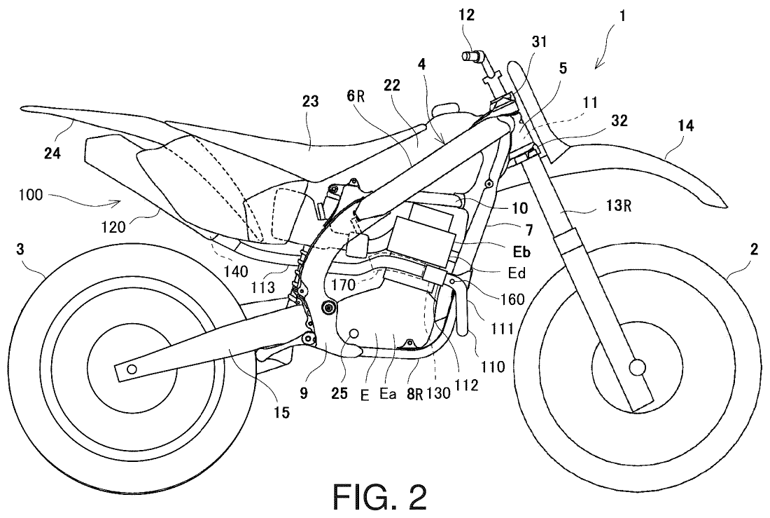

A straddled off-road traveling vehicle 1 according to the exemplary embodiment will be described with reference to FIGS. 1 and 2. FIGS. 1 and 2 are respectively left and right side views showing one example of the configuration of the straddled off-road traveling vehicle 1 according to the exemplary embodiment. The straddled off-road traveling vehicle 1 according to the present embodiment is a motorcycle of a motocross type which can travel on an irregular ground. In the following description, the “straddled off-road traveling vehicle 1” may be referred to as a “motorcycle 1.”

The motorcycle 1 includes a front wheel 2, a rear wheel 3, and a vehicle body frame 4. As frame elements, the vehicle body frame 4 includes a head pipe 5, a pair of main frames 6L and 6R as left and right main frames, a down frame 7, a pair of lower frames 8L and 8R as left and right lower frames, a pivot frame 9, and bridge frames 10. In the vehicle body frame 4, the frame elements are joined to each other by welding.

Herein, in the present specification and the claims, an upper direction, upward, a lower direction, downward, a front direction, forward, a rear direction, rearward, a left direction, leftward, a right direction, rightward, a lateral direction, and lateral indicate directions based on the motorcycle 1 located on a horizontal surface. The upper direction and upward indicate a direction from the horizontal surface toward the motorcycle 1. The lower direction and downward indicate a direction from the motorcycle 1 toward the horizontal surface. The front direction and forward indicate an advancing direction of the motorcycle 1. The rear direction, rearward, the left direction, leftward, the right direction, rightward, the lateral direction, and lateral indicate directions with respect to the front direction or forward.

The head pipe 5 is a tubular body including an axis extending in an upper-lower direction. The main frames 6L and 6R extend downward and rearward from an upper portion of the head pipe 5 while being inclined. The down frame 7 is located at a forward position relative to the main frames 6L and 6R and extends downward and rearward from a lower portion of the head pipe 5 while being inclined. The down frame 7 extends downward beyond the main frames 6L and 6R. The lower frames 8L and 8R extend downward from a lower portion of the down frame 7, curve, and extend rearward. The pivot frame 9 couples rear portions of the main frames 6L and 6R and rear portions of the lower frames 8L and 8R. The bridge frames 10 couple the main frames 6L and 6R and the down frame 7 so as to form gussets. The main frames 6L and 6R and the down frame 7 are joined to the head pipe 5 by welding. The bridge frames 10 are joined to the main frames 6L and 6R and the down frame 7 by welding.

The motorcycle 1 further includes a steering shaft 11 that is in the head pipe 5 and rotatable. An upper bracket 31 and an under bracket 32 are respectively attached to upper and lower portions of the steering shaft 11. The motorcycle 1 further includes: a handlebar 12 attached to the upper bracket 31; and a pair of front forks 13L and 13R as left and right front forks including respective upper portions connected to the upper bracket 31 and the under bracket 32. Lower portions of the front forks 13L and 13R support the front wheel 2 such that the front wheel 2 is rotatable. The motorcycle 1 further includes a front fender 14 located above the front wheel 2. A rider turns the handlebar 12 to steer the front wheel 2 through the steering shaft 11 and the front forks 13L and 13R.

The motorcycle 1 further includes: a swing arm 15 extending in a front-rear direction; and a rear suspension 16 extending in the upper-lower direction. A front portion of the swing arm 15 is supported by the pivot frame 9 such that the swing arm 15 is pivotable. A rear portion of the swing arm 15 supports the rear wheel 3 as a driving wheel such that the rear wheel 3 is rotatable. The rear suspension 16 is connected to the swing arm 15 and an upper portion of the pivot frame 9.

The motorcycle 1 further includes an internal combustion engine E. The internal combustion engine E is located in a space surrounded by the main frames 6L and 6R, the down frame 7, the lower frames 8L and 8R, and the pivot frame 9. The internal combustion engine E is fixed to portions of the vehicle body frame 4. In the present embodiment, the internal combustion engine E is an air-cooled internal combustion engine but is not limited to this. Therefore, the motorcycle 1 does not include a radiator around the internal combustion engine E.

The internal combustion engine E includes a crankcase Ea and a cylinder block Eb extending upward from an upper portion of the crankcase Ea. In the present embodiment, the cylinder block Eb is a cylinder block for a single cylinder, and one piston is accommodated in one cylinder bore so as to be slidable. However, the present embodiment is not limited to this. The cylinder block Eb is located rearward of the down frame 7 and does not project forward beyond the down frame 7. The cylinder block Eb is located in the vicinity of the down frame 7 so as to be inclined along the down frame 7. For example, the cylinder block Eb is inclined such that a sliding direction DP of the piston extends along the down frame 7. The cylinder block Eb includes: an intake port Ec located at a rear portion of the cylinder block Eb; and an exhaust port Ed located at a front portion of the cylinder block Eb.

The crankcase Ea accommodates: a crankshaft C connected to the piston through a connecting rod; and a transmission TM connected to the crankshaft C. The transmission TM is located rearward of the crankshaft C and transmits driving power of the crankshaft C to the rear wheel 3 through a power transmitting member 17, such as a chain or a belt.

The motorcycle 1 further includes: throttle equipment 19 connected to an intake pipe extending rearward from the intake port Ec; an intake duct 20 connected to a rear portion of the throttle equipment 19; and an air cleaner 21 connected to a rear portion of the intake duct 20. The motorcycle 1 further includes an exhaust system 100 connected to the exhaust port Ed.

The motorcycle 1 further includes a fuel tank 22 in a space between the main frames 6L and 6R. The fuel tank 22 is supported by the main frames 6L and 6R and projects upward beyond the main frames 6L and 6R.

The motorcycle 1 further includes a seat 23 which is located rearward of the fuel tank 22 and straddled by the rider. The motorcycle 1 further includes a rear fender 24 located below the seat 23, rearward of the air cleaner 21, and above the rear wheel 3.

The motorcycle 1 further includes a pair of steps 25 as left and right steps on which the rider straddling the seat 23 places his/her feet. In the present embodiment, the steps 25 are located at forward positions relative to the pivot frame 9 and in the vicinity of the pivot frame 9. However, the present embodiment is not limited to this. The steps 25 are located at upward positions relative to the lower frames 8L and 8R. The steps 25 are located at rearward positions relative to the cylinder block Eb. The rider's feet placed on the steps 25 are located at upward positions relative to the lower frames 8L and 8R.

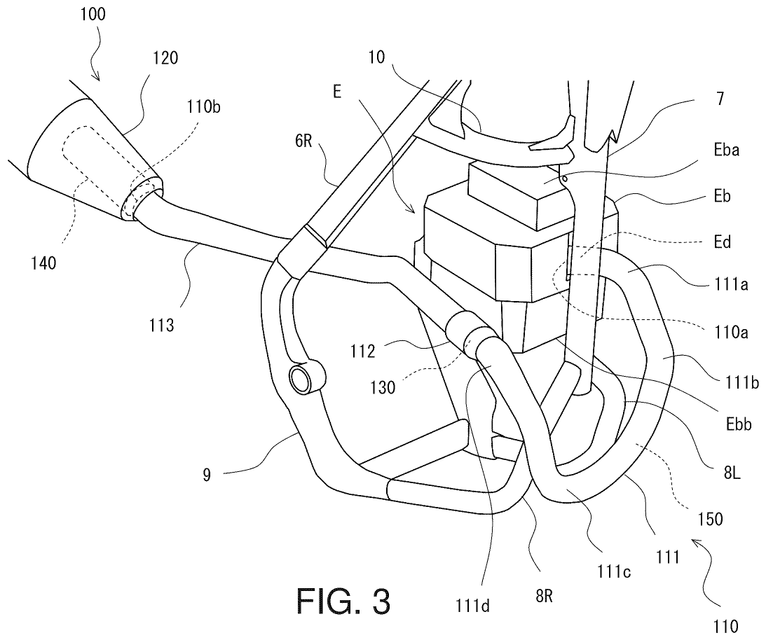

The configuration of the exhaust system 100 will be described with reference to FIGS. 2 and 3. FIG. 3 is a perspective view showing the configuration of the exhaust system 100 of the straddled off-road traveling vehicle 1 of FIG. 1 and its vicinity. The exhaust system 100 as a whole is located at a lateral space of the internal combustion engine E. In the present embodiment, the exhaust system 100 as a whole is located at a space rightward of the internal combustion engine E. FIG. 3 shows the cylinder block Eb of the internal combustion engine E. The exhaust system 100 includes an exhaust pipe 110, a silencer 120, a precatalyst 130, and a main catalyst 140. The exhaust pipe 110 defines an exhaust passage 150 through which the exhaust gas discharged from the exhaust port Ed of the internal combustion engine E is discharged to outside air. The precatalyst 130 is located at a portion of the exhaust pipe 110, and the main catalyst 140 is located at the silencer 120.

An upstream end 110a of the exhaust pipe 110 is connected to the exhaust port Ed of the cylinder block Eb. A downstream end 110b of the exhaust pipe 110 is connected to the silencer 120. To be specific, the exhaust passage 150 is connected to the silencer 120. The exhaust pipe 110 defines one exhaust passage 150 extending from the upstream end 110a to the downstream end 110b. The upstream end 110a of the exhaust pipe 110 is an end portion located at an upstream side in a flow direction of the exhaust gas in the exhaust passage 150, and the downstream end 110b of the exhaust pipe 110 is an end portion located at a downstream side in the flow direction of the exhaust gas in the exhaust passage 150.

The exhaust pipe 110 includes first, second, and third tube sections 111, 112, and 113 lined up in a direction from the upstream end 110a toward the downstream end 110b. The first tube section 111 includes the upstream end 110a and is connected to the exhaust port Ed. The second tube section 112 includes an upstream end connected to a downstream end of the first tube section 111 and has a larger inner diameter than the first tube section 111. The precatalyst 130 is located inside the second tube section 112.

The third tube section 113 includes an upstream end connected to a downstream end of the second tube section 112 and further includes the downstream end 110b. An inner diameter of the third tube section 113 is smaller than the inner diameter of the second tube section 112 at at least the upstream end of the third tube section 113. The downstream end 110b of the third tube section 113 extends inside the silencer 120.

The exhaust pipe 110 includes pipes coupled to each other. The positions of coupled portions of the pipes do not necessarily have to coincide with the positions of boundaries between the tube sections 111, 112, and 113 and the silencer 120.

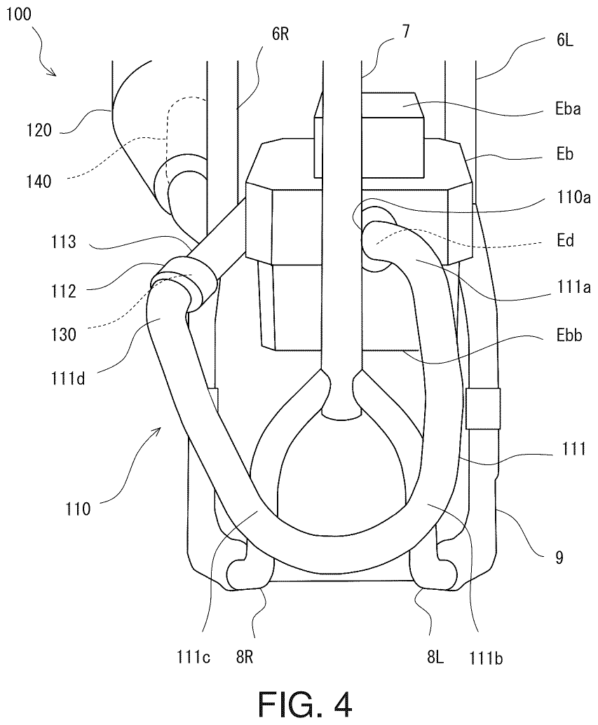

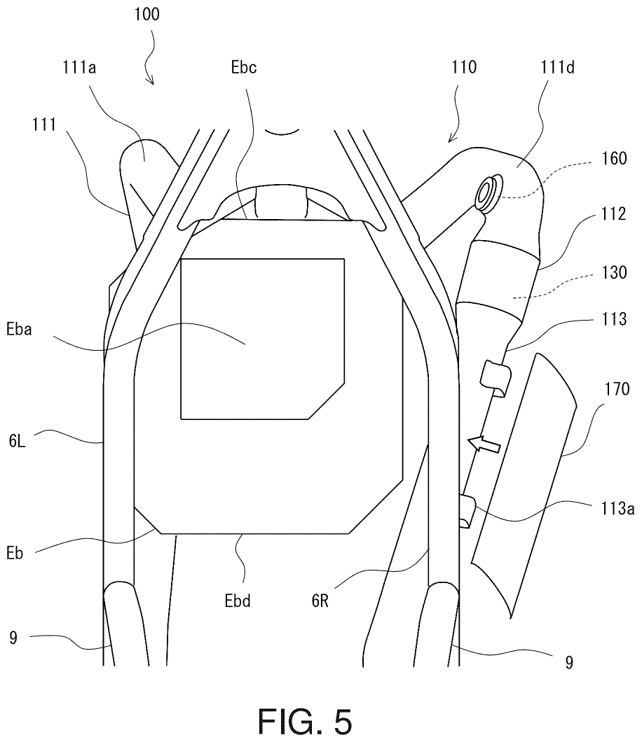

As shown in FIGS. 3 to 5, in the present embodiment, the exhaust port Ed is located at a position of the cylinder block Eb which is a position leftward of a center of the cylinder block Eb in the left-right direction. However, the present embodiment is not limited to this. FIGS. 4 and 5 are respectively a front view and a top view showing the configuration of the exhaust system 100 of the straddled off-road traveling vehicle 1 of FIG. 1 and its vicinity. The first tube section 111 extends from the exhaust port Ed, passes through a space leftward of the down frame 7, extends forward, and reaches a first curved portion 111a located at a position forward and leftward relative to the down frame 7. The first tube section 111 curves at the first curved portion 111a, extends downward, and reaches a second curved portion 111b located at a position forward of the lower frame 8L. The first tube section 111 curves at the second curved portion 111b, extends rightward, and reaches a third curved portion 111c located at a position forward of the lower frame 8R. The first tube section 111 curves at the third curved portion 111c, passes through a space rightward of the lower frame 8R, extends upward, and reaches a fourth curved portion 111d. The first tube section 111 curves at the fourth curved portion 111d, extends rearward, reaches a position rightward of the cylinder block Eb, and is connected to the upstream end of the second tube section 112.

The fourth curved portion 111d is located at a position forward and rightward relative to the cylinder block Eb. Moreover, the fourth curved portion 111d may be located at a forward position relative to the down frame 7. The fourth curved portion 111d is located at a height position between the lower end and upper end of the cylinder block Eb in the upper-lower direction. The fourth curved portion 111d may be located at an upward position relative to the crankcase Ea. Thus, the first tube section 111 extends from the exhaust port Ed, passes through a forward space relative to the down frame 7 and the lower frames 8L and 8R, and reaches a rightward position relative to the cylinder block Eb.

The second tube section 112 is located in a right lateral direction from the cylinder block Eb. The downstream end of the second tube section 112 is connected to the upstream end of the third tube section 113 at a position which is located in the right lateral direction from the cylinder block Eb.

The second tube section 112 is located at a height position between a lower end Ebb and upper end Eba of the cylinder block Eb in the upper-lower direction. In the present embodiment, the second tube section 112 is located closer to the lower end Ebb of the cylinder block Eb than to the upper end Eba of the cylinder block Eb. However, the present embodiment is not limited to this. The second tube section 112 may be located at a height position, which is equivalent in height to the exhaust port Ed or is a position downward of the exhaust port Ed in the upper-lower direction. In the present embodiment, the second tube section 112 is located at a height position which is a position downward of the exhaust port Ed. However, the present embodiment is not limited to this. In the present specification and the claims, the cylinder block includes both of the cylinder block and a cylinder head.

The second tube section 112 may be located at a position between a front end Ebc and rear end Ebd of the cylinder block Eb in the front-rear direction. In the present embodiment, the second tube section 112 is located closer to the front end Ebc of the cylinder block Eb than to the rear end Ebd of the cylinder block Eb. However, the present embodiment is not limited to this. The second tube section 112 does not project forward beyond the down frame 7. As shown in FIG. 2, the second tube section 112 is located at a position which is forward and upward from the steps 25 and upward from the lower frames 8L and 8R.

Moreover, in a right side view, the second tube section 112 may be located at such a position as to be projected on the cylinder block Eb. In the present embodiment, the entire second tube section 112 is projected on the cylinder block Eb. However, the present embodiment is not limited to this.

Moreover, to suppress a temperature decrease of the exhaust gas flowing into the second tube section 112, the second tube section 112 is located at a position closer to the exhaust port Ed than a middle point of the exhaust passage 150 in the flow direction of the exhaust gas. To be specific, the second tube section 112 is located at a position closer to the exhaust port Ed than a middle point of the exhaust pipe 110 in the flow direction of the exhaust gas. Furthermore, for the same purpose, the second tube section 112 may be located at a position within 1,000 millimeters from the exhaust port Ed along the exhaust passage 150. For example, a length of the first tube section 111 may be within 1,000 millimeters.

Moreover, to suppress a backflow that is the flow of the exhaust gas from the second tube section 112 toward the exhaust port Ed, the second tube section 112 may be located at a position away from the exhaust port Ed along the exhaust passage 150. There is a possibility that if the second tube section 112 is close to the exhaust port Ed, the backflow of the exhaust gas is caused by an interferential action of the precatalyst 130.

As shown in FIG. 2, an O₂ sensor 160 is located upstream of the second tube section 112 on the exhaust pipe 110. FIG. 5 shows an attaching portion of the O₂ sensor 160. The O₂ sensor 160 detects the concentration of oxygen in the exhaust gas. A detection result of the O₂ sensor 160 is used for driving control of the internal combustion engine E. The O₂ sensor 160 is attached to the first tube section 111. For example, the O₂ sensor 160 is attached to the fourth curved portion 111d or to a portion between the fourth curved portion 111d and the second tube section 112. The O₂ sensor 160 may be attached to the first tube section 111 so as to be located upstream of the precatalyst 130.

As shown in FIGS. 2 and 3, the third tube section 113 passes through a right lateral space of the cylinder block Eb, extends rearward, and curves. Moreover, the third tube section 113 passes through a space surrounded by the main frames 6L and 6R and the pivot frame 9 and reaches the silencer 120. Therefore, the third tube section 113 passes through an inside of the pivot frame 9 and the main frame 6R and extends to the silencer 120. The third tube section 113 is located at an upward position relative to the steps 25 and the lower frame 8R. The third tube section 113 may be located at an upward position relative to the crankcase Ea.

As shown in FIGS. 2 and 5, a heat guard 170 is attached to a portion 113a of the third tube section 113 which passes through the right lateral space of the cylinder block Eb. The heat guard 170 is a member which covers the portion 113a and blocks the transfer of heat radiated from the portion 113a. The heat guard 170 is a member that prevents a leg of the rider on the seat 23 from directly contacting the third tube section 113. The heat guard 170 is located at such a position that the leg of the rider may be located. The second tube section 112 is located at a forward position relative to the heat guard 170. The forward position is such a position that the second tube section 112 is not contacted by the rider's leg placed on the step 25. The heat guard 170 may have such a shape and size as to further cover the second tube section 112.

As shown in FIG. 2, the silencer 120 is located at a height position between the rear fender 24 and the rear wheel 3. The silencer 120 is located at an upward position relative to the swing arm 15. In the present embodiment, the silencer 120 is located at a position closer to the rear fender 24 than to the swing arm 15 and is inclined such that a rear end of the silencer 120 is located at an upward position relative to a front end of the silencer 120. However, the present embodiment is not limited to this. Therefore, the exhaust system 100 does not include a portion that projects downward beyond the lower frames 8L and 8R.

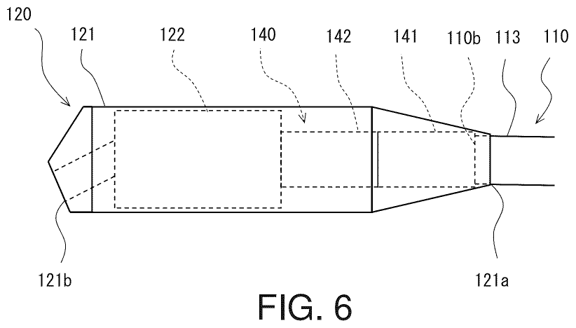

As shown in FIG. 6, the silencer 120 includes a tubular casing 121 and a silencing structure 122 located inside the casing 121. The third tube section 113 passes through an upstream end 121a of the casing 121 and extends inside the casing 121. The exhaust gas flowing from the third tube section 113 into the casing 121 flows through a downstream end 121b of the casing 121 to an outside. The silencing structure 122 includes a structure that reduces pulsation sounds of the exhaust gas. For example, to reduce the pulsation sounds, the silencing structure 122 may include one or more of: a structure in which a sound absorbing material, such as glass wool, is located around a channel of the exhaust gas; a structure in which the channel of the exhaust gas is made narrow; a structure in which the channel of the exhaust gas is offset; and a structure in which the channel of the exhaust gas branches.

As shown in FIG. 3, the precatalyst 130 is located inside the second tube section 112. For example, the precatalyst 130 has a columnar shape. Therefore, the precatalyst 130 has the same positional relation as the second tube section 112 with respect to the other components of the motorcycle 1. As shown in FIG. 6, the main catalyst 140 is located inside the casing 121 of the silencer 120. The main catalyst 140 is located upstream of the silencing structure 122 and is connected to the downstream end 110b of the third tube section 113. Therefore, the exhaust gas having flowed into the silencer 120 is subjected to a purifying action by the main catalyst 140, is subjected to a reducing action of the pulsation sounds by the silencing structure 122, and is discharged to outside air.

For the purpose of quickly obtaining purifying performance for purifying the exhaust gas after cold start of the internal combustion engine E, the motorcycle 1 includes the precatalyst 130. The precatalyst 130 is required to be able to purify the exhaust gas during warming-up of the internal combustion engine E. For the purpose of obtaining adequate purifying performance for purifying the exhaust gas of the internal combustion engine E during a normal operation after the warming-up, the motorcycle 1 includes the main catalyst 140.

The size of the main catalyst 140 in a radial direction of the flow direction of the exhaust gas is restricted by the casing 121 of the silencer 120. The main catalyst 140 includes a first catalyst 141 and a second catalyst 142 which are lined up in the flow direction of the exhaust gas. For example, each of the first catalyst 141 and the second catalyst 142 has a columnar shape. Since a length of the main catalyst 140 in the flow direction of the exhaust gas is secured by the first catalyst 141 and the second catalyst 142, a heat capacity of the main catalyst 140 is secured. In the present embodiment, the heat capacity of the first catalyst 141 and the heat capacity of the second catalyst 142 are the same as each other but may be different from each other. Each of the first catalyst 141 and the second catalyst 142 is one example of a divided main catalyst. The first catalyst 141 and the second catalyst 142 may be located in parallel in the flow direction of the exhaust gas.

The heat capacity of the precatalyst 130 is smaller than the heat capacity of the main catalyst 140. For example, the heat capacity of the precatalyst 130 may be not more than 50% of the heat capacity of the main catalyst 140. The heat capacity of the precatalyst 130 may be smaller than each of the heat capacity of the first catalyst 141 and the heat capacity of the second catalyst 142. Moreover, the heat capacity of the precatalyst 130 may be not more than 50% of each of the heat capacity of the first catalyst 141 and the heat capacity of the second catalyst 142.

To realize the heat capacities as above, the volume of the precatalyst 130 may be smaller than the volume of the main catalyst 140. The volume of the precatalyst 130 may be not more than 50% of the volume of the main catalyst 140. The volume of the precatalyst 130 may be smaller than each of the volume of the first catalyst 141 and the volume of the second catalyst 142. The volume of the precatalyst 130 may be not more than 50% of each of the volume of the first catalyst 141 and the volume of the second catalyst 142. The diameter and sectional area of the precatalyst 130 as above may be respectively smaller than the diameter and sectional area of each of the first catalyst 141 and the second catalyst 142. The diameter and sectional area of the precatalyst 130 are a diameter and a sectional area in the radial direction of the exhaust pipe 110, and the diameter and sectional area of each of the first catalyst 141 and the second catalyst 142 are a diameter and a sectional area in the radial direction of the casing 121 of the silencer 120. The precatalyst 130 as above can be reduced in size, and a projection amount of the second tube section 112 in the radial direction can be reduced.

To realize the heat capacities as above, the volume of a honeycomb body of the precatalyst 130 may be smaller than the volume of a honeycomb body of the main catalyst 140. The volume of the honeycomb body of the precatalyst 130 may be not more than 50% of the volume of the honeycomb body of the main catalyst 140. The volume of the honeycomb body of the precatalyst 130 may be smaller than each of the volume of the honeycomb body of the first catalyst 141 and the volume of the honeycomb body of the second catalyst 142. The volume of the honeycomb body of the precatalyst 130 may be not more than 50% of each of the volume of the honeycomb body of the first catalyst 141 and the volume of the honeycomb body of the second catalyst 142. The precatalyst 130 as above can be reduced in size, and the projection amount of the second tube section 112 in the radial direction can be reduced.

To realize the heat capacities as above, cell density of the precatalyst 130 may be lower than cell density of the main catalyst 140. The cell density of the precatalyst 130 may be not more than 50% of the cell density of the main catalyst 140. The cell density of the precatalyst 130 may be lower than each of the cell density of the first catalyst 141 and the cell density of the second catalyst 142. The cell density of the precatalyst 130 may be not more than 50% of each of the cell density of the first catalyst 141 and the cell density of the second catalyst 142. Thus, exhaust interference by the precatalyst 130 can be reduced.

To realize the heat capacities as above, the catalyst property of the precatalyst 130 may be superior to the catalyst property of the main catalyst 140. The catalyst property of the catalyst may be based on a use amount of catalyst material including precious metal, such as platinum (Pt), rhodium (Rh), and palladium (Pd). In this case, the use amount of catalyst material of the precatalyst 130 per unit volume may be larger than the use amount of catalyst material of the main catalyst 140 per unit volume. The use amount of catalyst material of the main catalyst 140 per unit volume may be not more than 50% of the use amount of catalyst material of the precatalyst 130 per unit volume. Thus, the cost reduction of the main catalyst 140 is realized.

The catalyst property of the catalyst may be based on the purifying performance of the catalyst material itself. The purifying performance of the catalyst material of the precatalyst 130 per unit volume may be higher than the purifying performance of the catalyst material of the main catalyst 140 per unit volume. The purifying performance of the catalyst material of the main catalyst 140 per unit volume may be not more than 50% of the purifying performance of the catalyst material of the precatalyst 130 per unit volume. Thus, regarding the main catalyst 140, it is unnecessary to use an expensive catalyst material, and therefore, the cost reduction is realized.

Each of the precatalyst 130, the first catalyst 141, and the second catalyst 142 has the heat capacity that is based on one or a combination of two or more of the above factors to realize the above heat capacities.

In the exhaust system 100 as above, the precatalyst 130 is located closer to the exhaust port Ed than the main catalyst 140, and has a smaller heat capacity than the main catalyst 140. Therefore, the precatalyst 130 can be quickly increased in temperature immediately after the start of the internal combustion engine E. Moreover, since the precatalyst 130 is located at the lateral space of the cylinder block Eb, the precatalyst 130 is increased in temperature also by the heat radiated from the cylinder block Eb. Therefore, the precatalyst 130 can exhibit 90% or more of its purifying performance within several tens of seconds (for example, 30 seconds) after the start of the internal combustion engine E. The precatalyst 130 can effectively purify the exhaust gas during the warming-up until the main catalyst 140 becomes such a state as to be able to exhibit the purifying performance. Even when the internal combustion engine E rotates at middle or high speed during the normal operation after the completion of the warming-up, the influence of the precatalyst 130 on the flow of the exhaust gas is small. The exhaust system 100 can adequately purify the exhaust gas by the main catalyst 140 without reducing the performance of the internal combustion engine E.

The foregoing has described the exemplary embodiment of the present disclosure. However, the present disclosure is not limited to the above embodiment. To be specific, various modifications and improvements may be made within the scope of the present disclosure. For example, embodiments prepared by variously modifying the embodiment and embodiments prepared by combining components in different embodiments are also included in the scope of the present disclosure.

For example, in the embodiment, the exhaust system 100 is used for the internal combustion engine E of a single cylinder but may be used for the internal combustion engine E of multi-cylinder. In this case, the precatalyst 130 is located downstream of the O₂ sensor 160. The precatalyst 130 may be located downstream of a manifold extending from the exhaust port Ed of the internal combustion engine E. The precatalysts 130 may be located at respective pipes included in the manifold.

In the embodiment, the main catalyst 140 includes the first catalyst 141 and the second catalyst 142. However, the present disclosure is not limited to this. The main catalyst 140 may include only one catalyst or may include three or more catalysts.

In the embodiment, in the exhaust system 100, the first and second catalysts 141 and 142 of the main catalyst 140 are located inside one silencer 120. However, the present disclosure is not limited to this. For example, the exhaust system 100 may include two silencers 120, the first catalyst 141 may be located inside one of the silencers 120, and the second catalyst 142 may be located inside the other silencer 120. Also in this case, the relation between the heat capacities of the precatalyst 130, the first catalyst 141, and the second catalyst 142 may be the same as that in the embodiment. When the main catalyst 140 includes three or more catalysts, the three or more catalysts may be located inside one silencer 120, or the three or more catalysts may be separately located inside two or more silencers 120.

Aspects of the technology of the present disclosure will be described below. An exhaust system according to a first aspect of the present disclosure is an exhaust system of a straddled off-road traveling vehicle, the exhaust system including: an exhaust passage extending from an exhaust port of an internal combustion engine of the straddled off-road traveling vehicle and including a lateral portion passing through a lateral space of the internal combustion engine; a silencer connected to the exhaust passage at a position downstream of the lateral portion in a flow direction of an exhaust gas; a main catalyst located inside the silencer; and a precatalyst located at the lateral portion and having a heat capacity smaller than a heat capacity of the main catalyst.

According to the first aspect, since the precatalyst is located at the lateral portion, the precatalyst can be prevented from projecting downward beyond the lower end of the internal combustion engine. Since the main catalyst is located inside the silencer, the main catalyst does not project downward beyond the silencer. Since the precatalyst is located at a position closer to the exhaust port than the main catalyst, and has a smaller heat capacity than the main catalyst, the precatalyst has higher warming-up performance than the main catalyst. The precatalyst can exhibit the purifying performance by being activated at an early state immediately after the start of the internal combustion engine and can purify the exhaust gas in a period from immediately after the internal combustion engine is started until the main catalyst is activated. Therefore, the precatalyst and the main catalyst can be located such that while securing a lower-side clearance required for the straddled off-road traveling vehicle, the purifying performance for purifying the exhaust gas can be exhibited from immediately after the start of the internal combustion engine.

The exhaust system according to a second aspect of the present disclosure may be configured such that in the first aspect, the precatalyst is located at a position closer to the exhaust port than a middle point of the exhaust passage in the flow direction of the exhaust gas.

According to the second aspect, the precatalyst is located at a position relatively close to the exhaust port. Therefore, a time required for the activation of the precatalyst immediately after the start of the internal combustion engine can be reduced.

The exhaust system according to a third aspect of the present disclosure may be configured such that in the first or second aspect, the precatalyst is located at a position within 1,000 millimeters from the exhaust port along the exhaust passage.

According to the third aspect, since the precatalyst is located at the above position, the time required for the activation of the precatalyst immediately after the start of the internal combustion engine can be reduced.

The exhaust system according to a fourth aspect of the present disclosure may be configured such that in any one of the first to third aspects, in a side view of the straddled off-road traveling vehicle, the precatalyst is located at a forward position relative to a rear end of a cylinder block of the internal combustion engine in a front-rear direction of the straddled off-road traveling vehicle.

According to the fourth aspect, the precatalyst may be located forward away from the leg of the rider riding the straddled off-road traveling vehicle. Therefore, the precatalyst that becomes high in temperature and the leg of the rider can be prevented from getting close to each other and contacting each other.

The exhaust system according to a fifth aspect of the present disclosure may be configured such that in any one of the first to fourth aspects, the precatalyst is located at an upward position relative to a lower end of the internal combustion engine in a height direction of the straddled off-road traveling vehicle.

According to the fifth aspect, the precatalyst is not located downward beyond the internal combustion engine. Therefore, in the straddled off-road traveling vehicle, the clearance at the lower side of the internal combustion engine is easily secured.

The exhaust system according to a sixth aspect of the present disclosure may be configured such that in any one of the first to fifth aspects, in a side view of the straddled off-road traveling vehicle, the precatalyst is located so as not to project forward in a front-rear direction of the straddled off-road traveling vehicle beyond a down frame of a vehicle body frame of the straddled off-road traveling vehicle, the down frame being located at a forward position relative to the internal combustion engine and extending downward from a head pipe of the vehicle body frame.

According to the sixth aspect, since the precatalyst does not project forward beyond the down frame, the damage of the precatalyst by contact can be prevented.

The exhaust system according to a seventh aspect of the present disclosure may be configured such that in any one of the first to sixth aspects, the main catalyst includes divided main catalysts, and the heat capacity of the precatalyst is smaller than a heat capacity of each of the divided main catalysts.

According to the seventh aspect, the heat capacity of the precatalyst is smaller than each of the heat capacities of the divided main catalysts. Regardless of whether the divided main catalysts are located in series or in parallel, the precatalyst can be activated more quickly than each divided main catalyst.

The exhaust system according to an eighth aspect of the present disclosure may be configured such that in any one of the first to seventh aspects, the heat capacity of the precatalyst is not more than 50% of the heat capacity of the main catalyst.

According to the eighth aspect, the heat capacity of the precatalyst is significantly smaller than the heat capacity of the main catalyst. Therefore, the precatalyst can be quickly activated.

The exhaust system according to a ninth aspect of the present disclosure may be configured such that in any one of the first to eighth aspects, purifying performance of the precatalyst per unit volume for purifying the exhaust gas is higher than purifying performance of the main catalyst per unit volume for purifying the exhaust gas.

According to the ninth aspect, the catalyst property of the main catalyst is inferior to the catalyst property of the precatalyst. Thus, the cost reduction of the main catalyst having a large heat capacity is realized. Therefore, the cost reduction of the exhaust system is realized.

A straddled off-road traveling vehicle according to one aspect of the present disclosure includes: the exhaust system according to any one of the first to ninth aspects; and the internal combustion engine.

According to the above aspect, the same effects as the exhaust system according to each aspect of the present disclosure can be obtained.

All of the numerals used herein, such as the ordinal numbers and those indicating quantities, are examples used to specifically describe the technology of the present disclosure, and the present disclosure is not limited to those example numerals. Connection relationships among the components herein are mere examples to specifically describe the technology of the present disclosure, and connection relationships that realize the functions of the present disclosure are not limited to these examples.

As the present disclosure may be embodied in various forms without departing from the scope of the essential features thereof, the illustrative embodiment and variations are therefore illustrative and not restrictive, since the scope of the present disclosure is defined by the appended claims rather than by the description preceding them. All changes that fall within metes and bounds of the claims, or equivalence of such metes and bounds thereof are therefore intended to be embraced by the claims.

What is claimed is:

1. An exhaust system of a straddled off-road traveling vehicle,
the exhaust system comprising:
an exhaust passage extending from an exhaust port of an internal combustion engine of the straddled off-road traveling vehicle and including a lateral portion passing through a lateral space of the internal combustion engine;
a silencer connected to the exhaust passage at a position downstream of the lateral portion in a flow direction of an exhaust gas;
a main catalyst located inside the silencer; and
a precatalyst located at the lateral portion and having a heat capacity smaller than a heat capacity of the main catalyst.

2. The exhaust system according to claim 1, wherein the precatalyst is located at a position closer to the exhaust port than a middle point of the exhaust passage in the flow direction of the exhaust gas.

3. The exhaust system according to claim 1, wherein the precatalyst is located at a position within 1,000 millimeters from the exhaust port along the exhaust passage.

4. The exhaust system according to claim 1, wherein in a side view of the straddled off-road traveling vehicle, the precatalyst is located at a forward position relative to a rear end of a cylinder block of the internal combustion engine in a front-rear direction of the straddled off-road traveling vehicle.

5. The exhaust system according to claim 1, wherein the precatalyst is located at an upward position relative to a lower end of the internal combustion engine in a height direction of the straddled off-road traveling vehicle.

6. The exhaust system according to claim 1, wherein in a side view of the straddled off-road traveling vehicle, the precatalyst is located so as not to project forward in a front-rear direction of the straddled off-road traveling vehicle beyond a down frame of a vehicle body frame of the straddled off-road traveling vehicle, the down frame being located at a forward position relative to the internal combustion engine and extending downward from a head pipe of the vehicle body frame.

7. The exhaust system according to claim 1, wherein:
the main catalyst includes divided main catalysts; and
the heat capacity of the precatalyst is smaller than a heat capacity of each of the divided main catalysts.

8. The exhaust system according to claim 1, wherein the heat capacity of the precatalyst is not more than 50% of the heat capacity of the main catalyst.

9. The exhaust system according to claim 1, wherein purifying performance of the precatalyst per unit volume for purifying the exhaust gas is higher than purifying performance of the main catalyst per unit volume for purifying the exhaust gas.

10. A straddled off-road traveling vehicle comprising:
the exhaust system according to claim 1; and
the internal combustion engine.
